(19) United States
(12) Patent Application Publication
(10) Pub. No.: US 2011/0135309 A1
(43) Pub. Date: Jun. 9, 2011

(54) WAVELENGTH DIVISION MULTIPLEXING-PASSIVE OPTICAL NETWORK (WDM-PON)

(75) Inventors: Han-Hyub LEE, Daejeon (KR); Seung-Hyun Cho, Daejeon (KR); Jie Hyun Lee, Daejeon (KR); Manyong Park, Daejeon (KR); Byoung Whi Kim, Daejeon (KR); Sang Soo Lee, Daejeon (KR)

(73) Assignee: Electronics and Telecommunications Research Institute, Daejeon (KR)

(21) Appl. No.: 12/882,307

(22) Filed: Sep. 15, 2010

(30) Foreign Application Priority Data
Dec. 8, 2009 (KR) 10-2009-0120900

(51) Int. Cl. H04J 14/02

(52) U.S. Cl. 398/79

(57) ABSTRACT

Provided is an Optical Line Terminal (OLT). The OLT may include a first Wavelength division multiplexer/demultiplexer (WDM MUX/DeMUX) to perform a wavelength demultiplexing on seed light received from a seed light source, and a second Wavelength division demultiplexer (WDM DeMUX) to receive, from at least one ONU/ONT, an upstream optical signal generated using the seed light having the wavelength demultiplexing performed, and to perform a wavelength multiplexing on the received upstream optical signal.

### CROSS-REFERENCE TO RELATED APPLICATION

This application claims the priority benefit of Korean Patent Application No. 10-2009-0120900, filed on Dec. 8, 2009, in the Korean Intellectual Property Office, the disclosure of which is incorporated herein by reference.

### BACKGROUND

1. Field

One or more embodiments relate to a Wavelength Division Multiplexing-Passive Optical Network (WDM-PON), and more particularly, to a WDM-PON that may minimize a nonlinear optical amplification phenomenon and a noise increase of an optical signal to thereby improve transmission characteristics of the optical signal.

2. Description of the Related Art

A dense Wavelength Division Multiplexing-Passive Optical Network (WDM-PON) may be well understood as a next generation optical network. In WDM-PON technologies, an optical transmission module may need to be non-wavelength dependent despite using a plurality of optical wavelengths. WDM-PON schemes satisfying this requirement have been actively studied, and as examples of WDM-PON schemes currently commercialized, a wavelength locking scheme and a wavelength reuse scheme may be given.

In the wavelength locking scheme, a phenomenon in which only light of an injected wavelength is amplified and light of remaining wavelengths is locked when injecting external seed light into a specific Fabry Perot Laser Diode (FP-LD) may be used

As the seed light, a Broadband Light Source (BLS) may be used. In this case, since a FP-LD mode where the wavelength is locked depending on a frequency of the injected light is determined, an accurate adjustment may be required.

In particular, in a case of signals where two FP-LD modes are selected by the injected light, the signals may increase mode division noise while passing through a WDM multiplexer (MUX) positioned in an Optical Line Terminal (OLT), thereby deteriorating noise characteristics.

In the wavelength reuse scheme dissimilar to the wavelength locking scheme, a Reflective Semiconductor Optical amplifier (RSOA) may be used as a light source for a communication. Downstream information of an optical signal including downstream data transmitted from the OLT may be eliminated in the RSOA mounted in an Optical Network Unit (ONU), so that the optical signal may be converted to similar Continuous Wave (CW) light.

Thereafter, the transformed light may be modulated into upstream data to be transmitted to the OLT. Thus, the modulated optical signal transmitted from the OLT to the ONU may act as the seed light in the RSOA mounted in the ONU.

In addition, the RSOA mounted in the OLT may also require the seed light, and thereby an external light source may be generally used as the seed light. As the external light source, the BLS may be generally used. In this case, a spectrum of output light may be wider than a spectrum of the injected light due to a nonlinear phenomenon generated in an optical amplification process within the RSOA, and a center wavelength may be moved to a side of a long wavelength.

Accordingly, a loss of an optical power may occur in a process where the optical signal outputted from the RSOA pass through the WDM MUX again, and a loss of data frequency elements required for transmitting signals may also occur. As a result, a transmission quality of signals operated in the WDM-PON may be deteriorated.

### SUMMARY

One or more embodiments provide a Wavelength Division Multiplexing-Passive Optical Network (WDM-PON) of a wavelength reuse scheme, which may minimize deterioration in a transmission quality occurring due to a loss of an optical power generated in a WDM multiplexer (MUX) positioned on a communication link and an Optical Line Terminal (OLT) and a loss of data frequency elements.

According to an aspect of one or more embodiments, there may be provided an Optical Line Terminal (OLT), including: a first Wavelength division multiplexer/demultiplexer (WDM MUX/DeMUX) to perform a wavelength demultiplexing on seed light received from a seed light source; and a second Wavelength division demultiplexer (WDM DeMUX) to receive, from at least one Optical network unit or optical network terminal (ONU/ONT), an upstream optical signal generated using the seed light having the wavelength demultiplexing performed, and to perform a wavelength multiplexing on the received upstream optical signal.

According to another aspect of one or more embodiments, there may be provided a seed light source which includes a first optical amplifier to ASE light and to output the amplified ASE light as a seed light, and enables a backward ASE light to re-inject the first optical amplifier to thereby amplify the re-injecting backward ASE light, the backward ASE light being outputted in an opposite direction of an output direction of the seed light.

According to another aspect of one or more embodiments, there may be provided an ONU/ONT, including: an optical power splitter to distribute downstream optical signal having been wavelength-multiplexed in a Wavelength division multiplexer, in a predetermined ratio; an optical receiver (Rx) to receive the distributed downstream optical signal; and a Reflective Semiconductor Optical amplifier (RSOA) to receive the distributed downstream optical signal, and to amplify and modulate the received downstream optical signal to generate the upstream optical signal.

According to another aspect of one or more embodiments, there may be provided a method of controlling an optical receiver in an optical network having improved optical transmission characteristics, the method including: converting, to electrical signals of a current signal type, optical signal received from an RSOA; amplifying the electrical signals in a linear manner to convert the amplified electrical signals to power signals; amplifying the power signals into output signals having a predetermined level; controlling a predetermined decision threshold value of the amplified output signals; and restoring received signals where the predetermined decision threshold value is controlled.

Additional aspects of embodiments will be set forth in part in the description which follows and, in part, will be apparent from the description, or may be learned by practice of the disclosure.

### EFFECT

According to an embodiment, a loss by spectrum division may be removed when passing through a Wavelength Division Multiplexing Multiplexer (WDM MUX) within a Wavelength Division Multiplexing-Passive Optical Network (WDM-PON) Optical Line Terminal (OLT) positioned on a communication link.

Also, according to an embodiment, a loss of data frequency elements may not occur even though an output spectrum of an optical signal is distorted by a nonlinear optical amplification phenomenon generated in a Reflective Semiconductor Optical amplifier (RSOA), thereby effectively transmitting signals.

### BRIEF DESCRIPTION OF THE DRAWINGS

These and/or other aspects will become apparent and more readily appreciated from the following description of embodiments, taken in conjunction with the accompanying drawings of which:

FIG. 1 is a diagram illustrating spectrum characteristics in a Wavelength Division Multiplexing-Passive Optical Network (WDM-PON);

FIG. 2 is a diagram illustrating a configuration of a WDM-PON system including a spectrum-sliced seed light having continuous optical output characteristics according to an embodiment;

FIG. 3 is a block diagram illustrating a seed light source according to an embodiment;

FIG. 4 is a diagram illustrating an optical amplifier of a seed light configured as an optical fiber optical amplifier according to an embodiment;

FIG. 5 is a diagram illustrating transmission characteristics of a Fabry Perot (FP) interferometer as an example of an optical wavelength filter;

FIG. 6 is a diagram illustrating a seed light source according to another embodiment;

FIG. 7 is a diagram illustrating a seed light source according to another embodiment;

FIG. 8 is a diagram illustrating a band pass filter of FIG. 7;

FIG. 9 is a diagram illustrating a seed light source according to another embodiment;

FIG. 10 is a diagram illustrating a seed light source according to another embodiment;

FIG. 11 is a diagram illustrating a configuration of the seed light source of FIG. 10, in detail;

FIG. 12 is a diagram illustrating a comparison between output spectrums of a conventional WDM-PON and a WDM-PON according to an embodiment;

FIG. 13 is a diagram illustrating a configuration of a WDM-PON system including a spectrum-sliced seed light having continuous optical output characteristics according to another embodiment;

FIG. 14 is a diagram illustrating a received signal in a general optical receiver;

FIG. 15 is a diagram illustrating a configuration of an optical receiver according to an embodiment;

FIG. 16 is a graph illustrating a change performance of an output power level with respect to an input optical power in three types of pre-amplifiers in a WDM-PON having improved optical transmission characteristics according to an embodiment;

FIGS. 17 to 19 are diagrams illustrating a change of a decision threshold value depending on a change of an output power level in a WDM-PON having improved optical transmission characteristics according to an embodiment;

FIGS. 20A, 20B, and 20C are output eye diagrams with respect to an offset input voltage value of a second post-amplifier according to an embodiment;

FIG. 21 is a diagram illustrating a configuration of an offset voltage generation unit 1570 according to an embodiment;

FIGS. 22A, 22B, 23A, and 23B are graphs illustrating a transmission test performance result in an optical receiver (Rx) according to an embodiment;

FIG. 24 is a diagram illustrating an improved result of a transmission penalty generated by retroreflection noise, by adopting an optical receiver according to an embodiment;

FIG. 25 is a block diagram illustrating an ONU/ONT in a WDM-PON having improved optical transmission characteristics according to an embodiment;

FIG. 26 is a flowchart illustrating a method of restoring received signals in an optical receiver (Rx) according to an embodiment; and

FIG. 27 is a diagram illustrating an optical signal inputted to a Reflective Semiconductor Optical amplifier (RSOA) from a WDM-PON having improved optical transmission characteristics according to another embodiment, an optical signal outputted from the RSOA, and a band pass spectrum of a first WDM multiplexer (MUX).

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

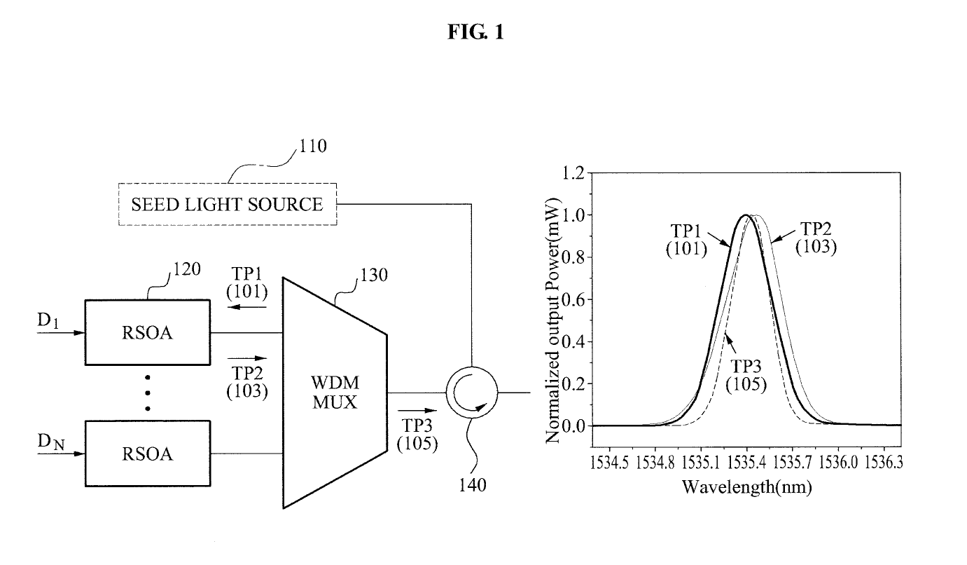

FIG. 1 is a diagram illustrating spectrum characteristics in a Wavelength Division Multiplexing-Passive Optical Network (WDM-PON). More specifically, a seed light (TP1) 101 of a seed light source 110 injected into a Reflective Semiconductor Optical amplifier (RSOA) 120 in WDM-PON having improved optical transmission characteristics, an output light TP2 103 amplified and outputted from the RSOA 120, and a spectrum of an output light TP3 105 passing through a WDM multiplexer (MUX) 130 are illustrated in FIG. 1.

Referring to FIG. 1, a loss of an optical signal in a long wavelength band may be generated while passing through the WDM MUX 130.

To minimize the loss, an Arrayed Waveguide Gratin (AWG), that is, an optical multiplexing device where a band pass is flat may be used as the WDM MUX, however, the AWG may not completely remove a widened spectrum phenomenon generated in the RSOA and an optical filtering effect generated in the WDM MUM.

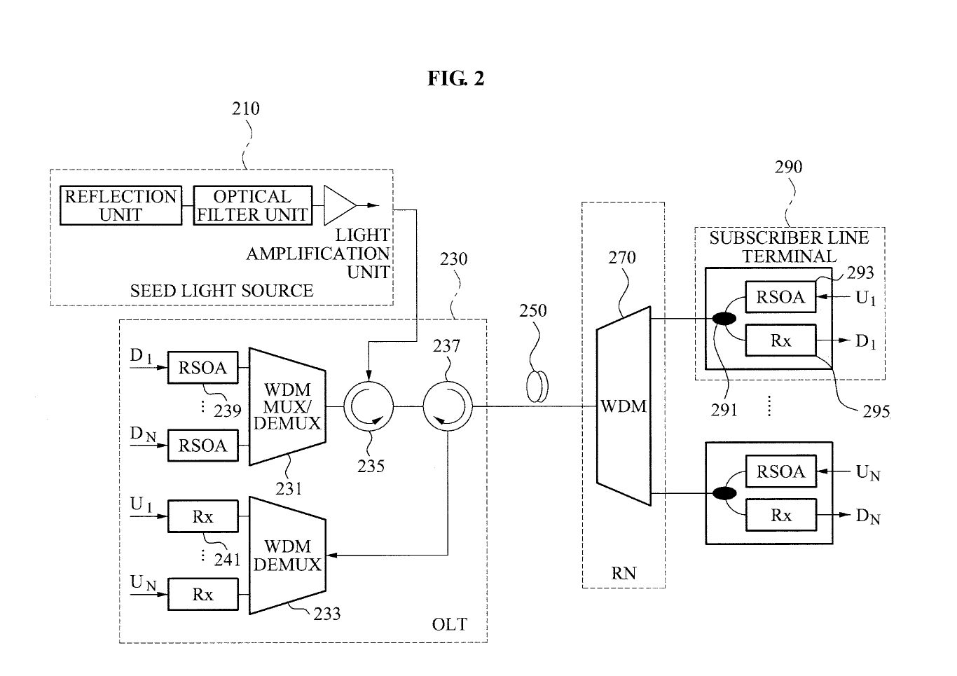

FIG. 2 is a diagram illustrating a configuration of a WDM-PON system including a spectrum-sliced seed light 100 having continuous optical output characteristics according to an embodiment.

Referring to FIG. 2, a WDM-PON system of a wavelength reuse scheme according to an embodiment includes a seed light source 210, an Optical Line Terminal (OLT) 230, an optical fiber 250, a Remote Node (RN) including a third Wavelength division multiplexer 270, and at least one ONU/ONT 290.

The seed light source 210 may include an optical amplifier that may amplify an ASE light to output the amplified light as a seed light, and may re-inject, into the optical amplifier, a backward ASE light outputted in an opposite direction of the seed light to amplify the injected backward ASE light.

For example, the seed light source 210 may include an optical amplification unit, an optical filter unit, and a reflection unit.

The OLT 230 may include a first Wavelength division multiplexer/demultiplexer (WDM MUX/DeMUX) 231, a second Wavelength division demultiplexer(WDM DeMUX) 233, an RSOA 239, and an optical receiver (Rx) 241.

Depending on embodiments, a Fabry Perot Laser Diode (FP-LD) may be used instead of using the RSOA 239.

The first Wavelength division multiplexer/demultiplexer 231 may perform a wavelength demultiplexing on the seed light received from the seed light source 210.

The first Wavelength division multiplexer/demultiplexer 231 may be connected to at least one RSOA 239 that may amplify and modulate the seed light having wavelength demultiplexing performed to thereby generate a downstream optical signal, and receive the downstream optical signal generated from the RSOA 239 to perform a wavelength demultiplexing on the received downstream optical signal.

The downstream optical signal having wavelength demultiplexing performed in the first Wavelength division multiplexer/demultiplexer 231 may be transmitted to the RN, that is, the third Wavelength division multiplexer 270 through a first optical circulator 235 and the optical fiber 250.

A downstream optical signal of the respective wavelengths where the wavelength demultiplexing is performed in the third Wavelength division multiplexer 270 may be transmitted to the ONU/ONT 290 connected through the optical fiber 250. Next, an upstream optical signal generated in the ONU/ONT 290 may be wavelength-multiplexed in the third Wavelength division multiplexer 270, and then the wavelength-multiplexed upstream optical signal may be transmitted to the OLT 230.

The second Wavelength division demultiplexer 233 of the OLT 230 may receive the upstream optical signal generated in the ONU/ONT 290 through the third Wavelength division multiplexer 270 and the second optical circulator 237, and perform a demultiplexing on a wavelength of the received upstream optical signal.

In this instance, the first Wavelength division multiplexer/demultiplexer 231, the second Wavelength division demultiplexer 233, and third Wavelength division multiplexers 270 may have a flatter and wider band pass than an optical bandwidth of the seed light outputted from the seed light source 210.

Also, the second Wavelength division demultiplexer 233, and third Wavelength division multiplexers 270 may have the same optical characteristics as optical characteristics of the first Wavelength division multiplexer/demultiplexer 231.

The optical characteristics may be used for enabling wavelengths to pass through a filter band having the same wavelengths of specific channels of the WDM-PON system and having a bandwidth of the same wavelength. Here, the optical characteristics may be used as a concept including a wavelength band passing through a filter.

The second Wavelength division demultiplexer 233 may be connected to at least one optical receiver (Rx) 241, and the optical receiver (Rx) 241 may receive, from the second Wavelength division demultiplexer 233, an upstream optical signal where a wavelength demultiplexing is performed.

Depending on embodiments, the optical receiver (Rx) 241 may include an apparatus Diffusion-Limited Aggregation (DLA) of adjusting a voltage threshold value by determining a level of the upstream optical signal having the wavelength demultiplexing performed. The DLA will be described later.

The OLT 230 may include the second optical circulator 237 for transmitting, to the second Wavelength division demultiplexer 233, the upstream optical signal having been wavelength multiplexed in the third Wavelength division multiplexer 270, and may be connected to the RN 270 using the optical fiber 250.

The third Wavelength division multiplexer 270 may have the same optical characteristics as those of the first and second Wavelength division demultiplexers 231 and 233 included in the OLT 230.

The ONU/ONT 290 may include an optical power splitter 291, an RSOA 293, and an optical receiver (Rx) 295.

The optical power splitter 291 may distribute the downstream optical signal having been wavelength-divided in the third Wavelength division multiplexer 270 in a predetermined ratio (for example, 50:50).

The optical receiver (Rx) 295 may receive the distributed downstream optical signal from the optical power splitter 291.

The RSOA 293 may receive the distributed downstream optical signal from the optical power splitter 291, and reuse, that is, amplify and modulate the received downstream optical signal to thereby generate an upstream optical signal.

In this instance, the FP-LD may be used to replace the RSOA 293.

Here, the at least one ONU/ONT 290 may be connected to the OLT 230 through the third Wavelength division multiplexer 270 having the same optical characteristics as those of the first Wavelength division multiplexer/demultiplexers 231 and second Wavelength division demultiplexers 233.

The first Wavelength division multiplexer/demultiplexers 231, second Wavelength division demultiplexers 233 and third Wavelength division multiplexers 270 may perform a wavelength multiplexing or a wavelength demultiplexing in accordance with an input direction of a signal, and depending on embodiments, a Wavelength division multiplexer having a flat pass band or a thin filter may be used instead of the first Wavelength division multiplexer/demultiplexers 231, second Wavelength division demultiplexers 233 and third Wavelength division multiplexers 270.

Hereinafter, the seed light source 210 of FIG. 2 will be further described.

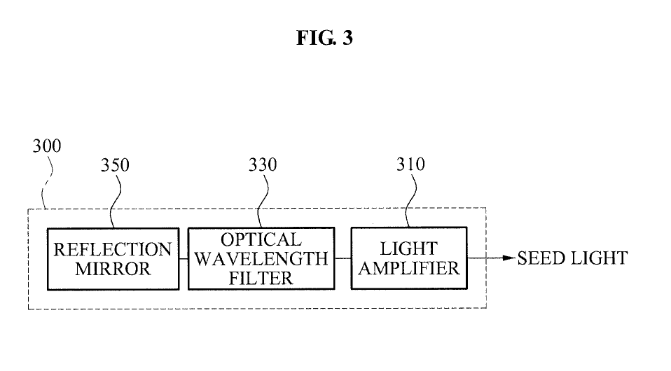

FIG. 3 is a block diagram illustrating a seed light source 300 according to an embodiment.

Referring to FIG. 3, the seed light source 300 may spectrum-slice a backward ASE light generated in an optical amplifier, and re-inject the spectrum divided light into the optical amplifier to be amplified.

Specifically, the seed light source 300 may include the optical amplifier that may amplify a ASE light and output the amplified ASE light as a seed light, and re-inject, into the optical amplifier, a backward ASE light outputted in an opposite direction of the seed light to thereby amplify the backward ASE light.

Thus, an optical bandwidth for each channel of the seed light outputted from the seed light source may be more narrowed than a band pass of the first Wavelength division multiplexer/demultiplexer, and consequently, a loss of signals may be reduced when the seed light passes through the first Wavelength division multiplexer/demultiplexer.

The seed light source 300 may include an optical amplifier 310, an optical wavelength filter 330, and a reflection mirror 350.

Here, an ASE light may denote a light exerted within the seed light source, and may be different from the seed light, that is, a light outputted from the seed light source.

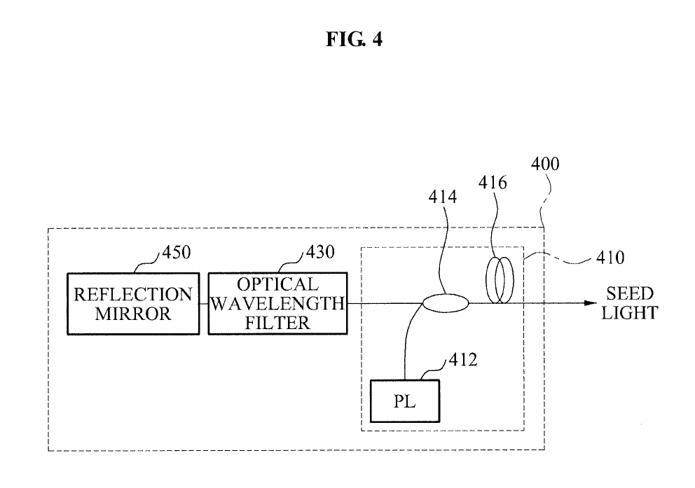

The optical amplifier 310 may amplify the ASE light to output the amplified light. Here, the optical amplifier 310 may be implemented as a semiconductor optical amplifier in accordance with a system implementation scheme, or implemented as an optical fiber optical amplifier as illustrated in FIG. 4.

The optical wavelength filter 330 may receive a backward ASE light outputted in an opposite direction of an output direction of the seed light outputted from the optical amplifier 300, and spectrum-slice the received light by transmitting the received backward ASE light through the optical wavelength filter 330 in a periodic frequency interval. In this instance, the optical wavelength filter 330 may adjust an interval or a width of a spectrum divided in accordance with output characteristics of the seed light.

The reflection mirror 350 may reflect the ASE light having been spectrum-sliced through the optical wavelength filter 330, and re-inject the reflected light into the optical wavelength filter 330.

FIG. 4 is a diagram illustrating an optical amplifier 310 of a seed light configured as an optical fiber optical amplifier 410 according to an embodiment.

Referring to FIG. 4, the optical fiber optical amplifier 410 may include a pump laser (PL) 412, an optical wavelength coupler 414, and an optical fiber (Erbium-Doped Fiber, EDF) 416, that is, a gain medium.

The PL 412 may generate a pump light for generating a carrier by injecting an external light into the optical fiber (EDF), that is, by pumping the optical fiber (EDF).

The optical wavelength combiner 414 may inject the pump light of the PL 412 into the EDF 416, that is, the gain medium, and depending on embodiments, the optical wavelength coupler 414 may be implemented by an optical coupled device such as an optical coupler and the like.

Here, the EDF 416 may include an optical fiber where erbium, that is, an optical amplification medium is doped.

Referring to FIGS. 3 and 4, operations of the seed light source adopting the optical fiber optical amplifier 410 will be herein described.

When the pump light enters by the PL 412, an ASE light may be simultaneously outputted in the output direction (right side, forward direction) of the seed light in the EDF 416 and the opposite direction (the left side, backward direction).

A backward ASE light continuously outputted in a relatively wide wavelength band may be inputted to an optical wavelength filter 430 mounted in a rear end of the optical amplifier 410.

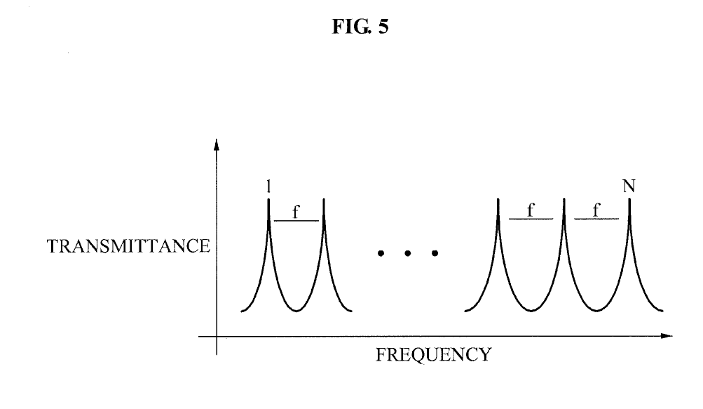

The backward ASE light inputted through a single terminal may be spectrum-sliced in a predetermined frequency interval (f) as illustrated in FIG. 5 in accordance with periodic optical transmission characteristics of the optical wavelength filter 430, and outputted into the single terminal.

FIG. 5 is a diagram illustrating transmission characteristics of a Fabry Perot (FP) interferometer as an example of an optical wavelength filter 430.

An interval and width of a pass spectrum of the optical wavelength filter 430 may be adjusted in accordance with output characteristics of a seed light required in a WDM-PON.

The optical wavelength filter 430 may be implemented by the FP interferometer using an interference phenomenon generated in an optical system including a pair of reflection mirrors. A light having been wavelength-divided in the optical wavelength filter 430 may be reflected on the reflection mirror 450 to be inputted into the EDF 416 using again the optical wavelength filter 430.

In the above described seed light source, the backward ASE light generated in the optical fiber optical amplifier 410 may be spectrum-sliced to re-inject the optical amplifier, and then provided to the OLT 230, so that a loss occurring due to a spectrum division generated when the backward ASE light passes through the Wavelength division multiplexer (WDM) mounted in the OLT 230 may be removed. As a result, the OLT of the WDM-PON may be effectively operated.

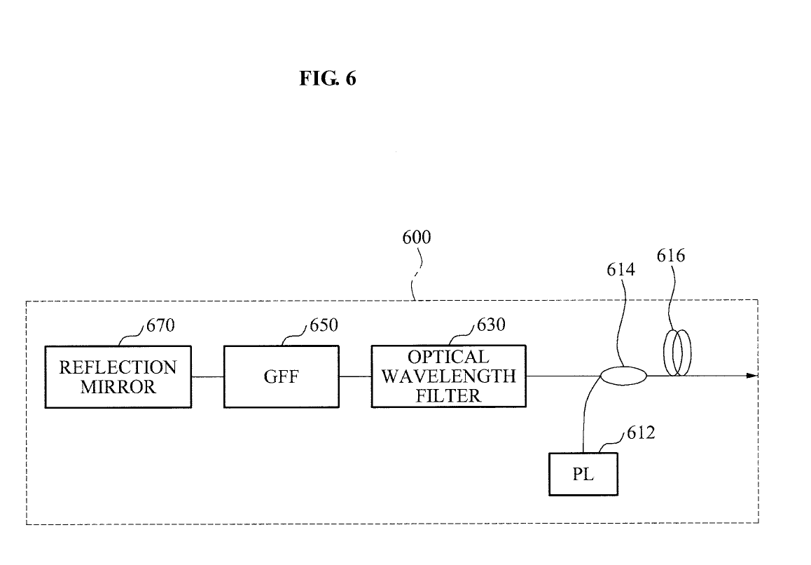

FIG. 6 is a diagram illustrating a seed light source 600 according to another embodiment.

Referring to FIG. 6, the seed light source 600 may further include a Gain Flattening Filter (GFF) 650 in addition to the configuration of the seed light source of FIG. 4.

As described above, the seed light (or the ASE light) may be divided into a plurality of channels having been spectrum-sliced while passing through the optical wavelength filter, and the GFF 650 may adjust a loss for each channel of the backward ASE light having been spectrum-sliced to flatten an intensity for each channel of the seed light outputted from the seed light source.

Here, the GFF 650 may be positioned between an optical wavelength filter 630 and a reflection mirror 670.

Depending on embodiments, a semiconductor optical amplifier may be used instead of an optical fiber (EDF and PDF) optical amplifier.

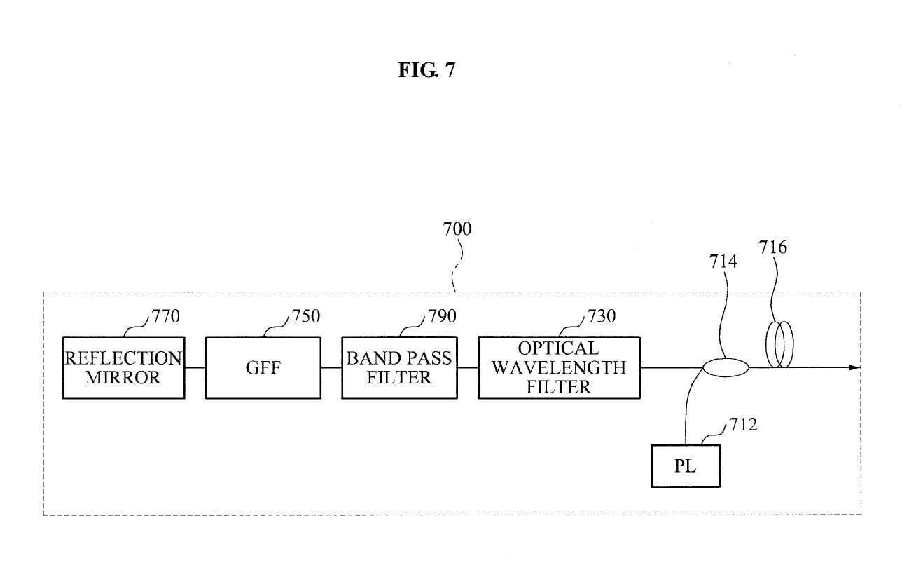

FIG. 7 is a diagram illustrating a seed light source 700 according to another embodiment.

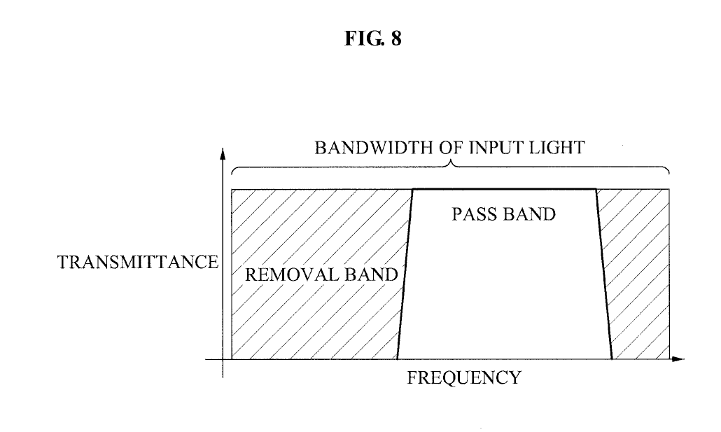

Referring to FIG. 7, the seed light source 700 may further a band pass filter 790 positioned between a GFF 750 and an optical wavelength filter 730, and characteristics of the band pass filter 790 will be described with reference to FIG. 8.

FIG. 8 is a diagram illustrating the band pass filter 790 of FIG. 7.

Referring to FIG. 8, the band pass filter 790 may transmit only a frequency of a specific band (or a predetermined band) of channels of the backward ASE light having been spectrum-sliced, so that a number of channels of the finally outputted seed light may be adjusted.

In FIG. 7, the band pass filter 790 may be positioned between the GFF 750 and the optical wavelength filter 730, however, the embodiments are not limited thereto. Thus, the band pass filter 790 may be positioned in any position between a reflection mirror 770 and an optical fiber optical amplifier.

Also, as illustrated in FIG. 7, the seed light source 700 may use the semiconductor optical amplifier instead of the refection mirror 770 and the optical fiber optical amplifier including a pump light source (PL) 712, an optical coupled device 714, and an optical fiber 716.

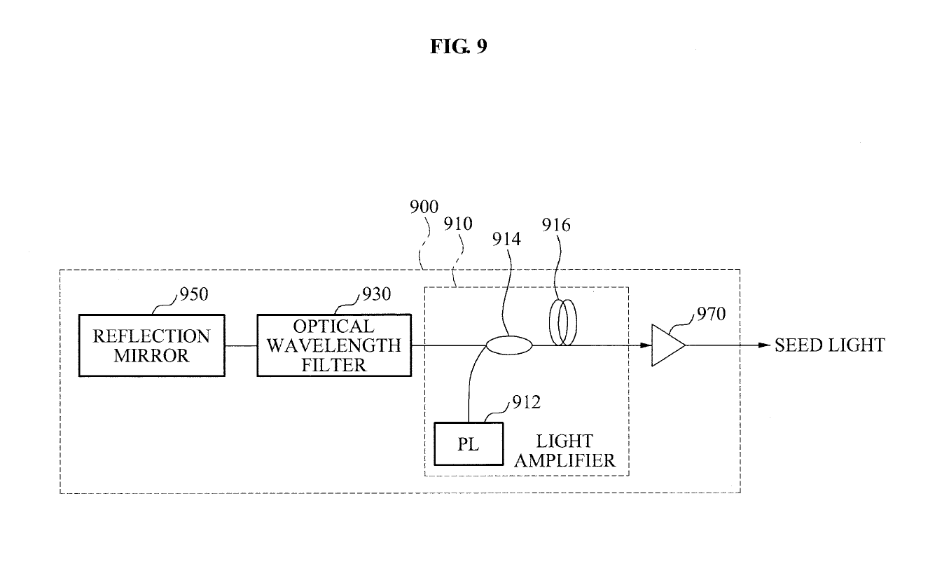

FIG. 9 is a diagram illustrating a seed light source 900 according to another embodiment.

Referring to FIG. 9, the seed light source 900 may further include a second optical amplifier 970 that may re-amplify a seed light outputted from the optical amplifier 910. An output power of a light having been spectrum-sliced may be improved by the addition of the second optical amplifier 970.

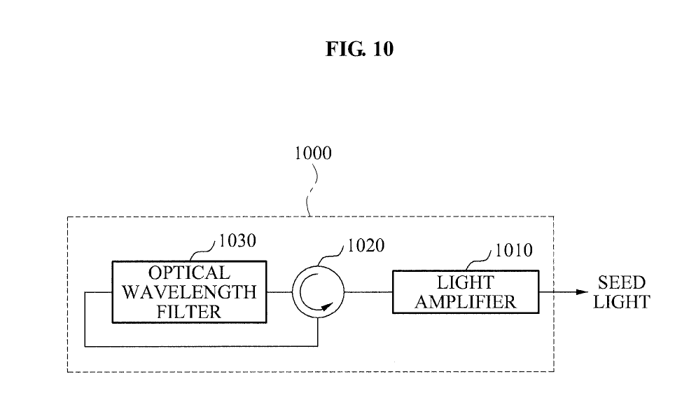

Also, the optical amplifier 910 may be implemented by an optical fiber optical amplifier of FIG. 10 or the semiconductor optical amplifier.

To re-inject, into the optical amplifier 310, the left direction-ASE light outputted from the optical amplifier 310 of the seed light source 300, the optical circulator, which will be described with reference to FIG. 10, may be used instead of the reflection mirror 350.

FIG. 10 is a diagram illustrating a seed light source 1000 according to another embodiment.

Referring to FIG. 10, the seed light source 1000 includes an optical amplifier 1010, an light circulation device 1020, and an optical wavelength filter 1030.

The optical amplifier 1010 may amplify an ASE light to output the amplified ASE light as a seed light.

The light circulation device 1020 may be positioned between the optical amplifier 1010 and the optical wavelength filter 1030, so that the light circulation device 1020 may circulate the ASE light outputted from the optical amplifier 1010 using the optical wavelength filter 1030, and enable the ASE light having been spectrum-sliced through the optical wavelength filter 1030 to re-inject the optical amplifier 1010.

The optical wavelength filter 1030 may receive a backward ASE light outputted in an opposite direction of an output direction of the seed light, and transmit the received light in a periodic frequency interval to spectrum-sliced the transmitted light.

Here, as the light circulation device 1020, an optical circulator may be used.

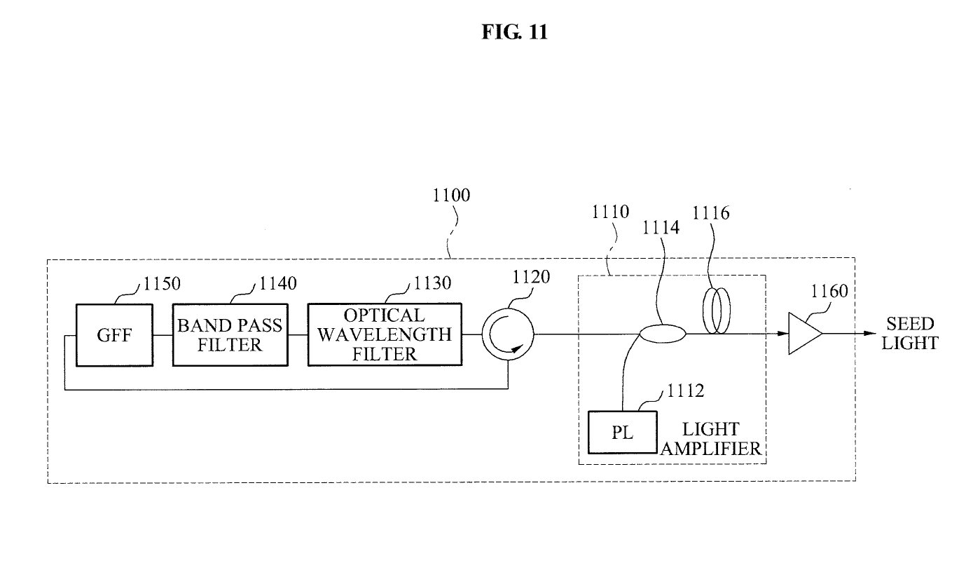

FIG. 11 is a diagram illustrating a configuration of the seed light source 1000 of FIG. 10, in detail.

Referring to FIG. 11, the seed light source 1000 may use the optical fiber optical amplifier illustrated in FIG. 3 as an optical amplifier 1110, and further include a GFF 1150 and a band pass filter 1140 which are positioned between an optical wavelength filter 1130 and an optical circulator 1120.

The band pass filter 1140 may transmit only a frequency of a specific band (or a predetermined band) of channels of a backward ASE light having been spectrum-sliced between the GFF 1150 and the optical wavelength filter 1130 to thereby adjust a number of channels of the finally outputted seed light.

The GFF 1150 may adjust a loss for each channel of the backward ASE light having been spectrum-sliced between the optical wavelength filter 1130 and the optical circulator 1120 to thereby flatten an intensity of signals for each channel of the seed light outputted from the seed light source.

In FIG. 11, the seed light source 1110 including both the GFF 1150 and the band pass filter 1140 is illustrated, however, the embodiments are not limited thereto. Thus, the seed light source may be configured of only one of the GFF 1150 and the band pass filter 1140, as necessary.

In addition, a second optical amplifier 1160 may be used for improve an optical power having been spectrum-sliced, which is outputted from the optical amplifier 1110, and may be selective used in accordance with a system implementation scheme.

As for an operation of the seed light source 1100 of FIG. 11, a pump light may enter the optical fiber 1116 by a pump light source (PL) 1112, and a seed light, that is, an ASE light may be outputted in an opposite direction (the left side) of an output direction of the seed light, from an optical fiber 1116. An ASE light outputted in a left direction from the optical amplifier 1110 may be inputted into the optical circulator 1120 to be transferred to the optical wavelength filter 1130, and the inputted ASE light may be transmitted in a periodic frequency interval using the optical wavelength filter 1130 to thereby output the seed light having been spectrum-sliced.

As for the above described ASE light having been spectrum-sliced, only the spectrum-sliced ASE light of a desired bandwidth may be transmitted using the band pass filter 1140, and the transmitted ASE light may be re-inputted into the optical circulator 1120 while passing through the GFF 1150. Thereafter, the spectrum-sliced ASE light inputted into the optical circulator 1120 may be inputted into the optical fiber 1116, and an optical power of the inputted ASE light may be amplified in the second optical amplifier 1160 to be transferred to the seed light.

As described above, also in the seed light source 1100 adopting the optical circulator 1120, the backward ASE light generated in the optical fiber optical amplifier 1110 may be spectrum-sliced, and then re-inject the optical fiber optical amplifier 1110 through the optical circulator 1120 to be provided as the seed light.

Thus, a loss due to a spectrum division occurring when the seed light passes through the Wavelength division multiplexer(WDM) mounted in the OLT may be reduced, so that the OLT of the dense WDM-PON may be effectively operated.

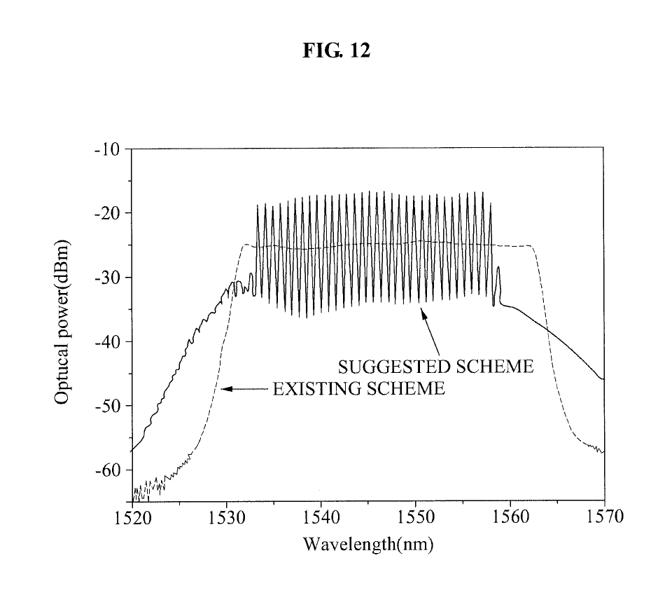

In FIG. 12, a comparison between an output spectrum of each of the seed light sources having various configurations according to embodiments and an output spectrum of a conventional BLS is illustrated.

FIG. 12 is a diagram illustrating a comparison between output spectrums of a conventional WDM-PON and a WDM-PON according to an embodiment.

Referring to FIG. 12, a seed light source according to an embodiment may spectrum-slice an ASE light inside of the seed light source, and re-amplify each spectrum divided ASE light, so that a loss due to the spectrum division occurring in the OLT of the WDM-PON may be reduced.

Accordingly, the seed light source according to an embodiment may show superior output performance in comparison with the conventional BLS as illustrated in FIG. 12.

Also, the seed light source according to an embodiment may equalize an optical power between divided spectrums by adopting the GFF, so that a spectrum-sliced light having the equalized optical power may be obtained as a state of having been wavelength multiplexed.

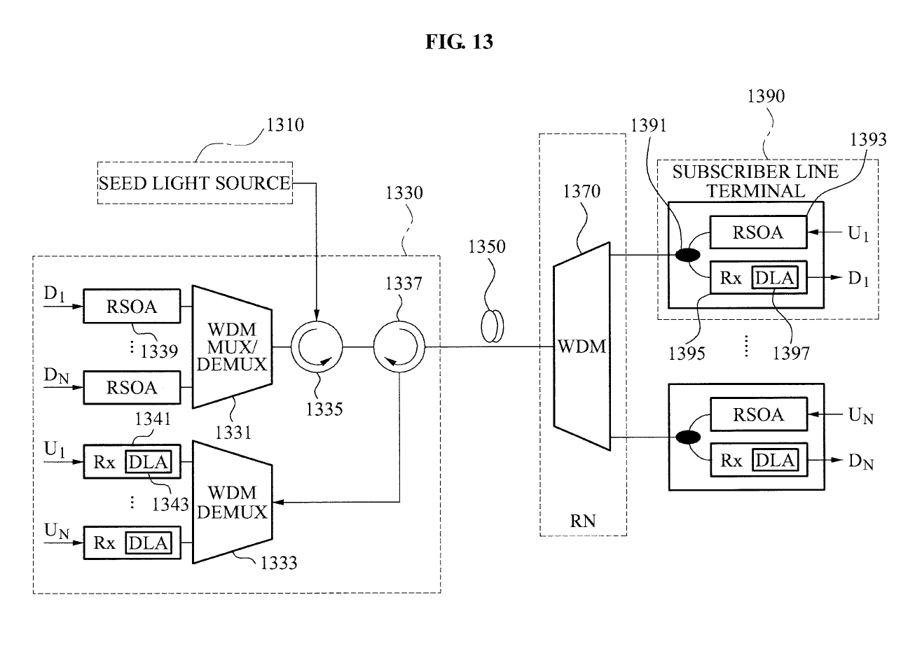

FIG. 13 is a diagram illustrating a configuration of a WDM-PON system including a spectrum-sliced seed light having continuous optical output characteristics according to another embodiment.

The WDM-PON system of FIG. 13 according to another embodiment may have the same configuration as the WON-PON system described in FIGS. 2 to 12, however, there may exist only a difference there between in apparatuses (DLA) 1343 and 1361 for adjusting a voltage threshold value by determining levels 1 and 0 of an upstream optical signal or a downstream optical signal which are received in a reception unit of an ONU/ONT and an OLT.

The WDM-PON system according to an embodiment may adopt an optical receiver having a voltage threshold value variable function that may change a decision threshold value by changing the voltage threshold value, so that an extinction ratio of the downstream optical signal may increase up to a predetermined level, thereby improving a transmission quality of the downstream optical signal.

Also, an input optical power operation range of a Reflective Semiconductor Optical amplifier (RSOA) may be reduced up to a gain saturation input optical power level or less, so that a link power budget may be improved.

Also, upstream/downstream transmission penalty due to a backward reflection related optical strength noise generated at the time of bidirectional transmission of a single optical fiber may be improved, and a transmission quality of the upstream optical signal may be improved due to the increased extinction ratio of the downstream optical signal. In addition, when using a broadband optical source based on an optical amplifier where an erbium having been spectrum-sliced as the seed light is added, the transmission quality may be improved due to an increase in generated relative optical strength noise.

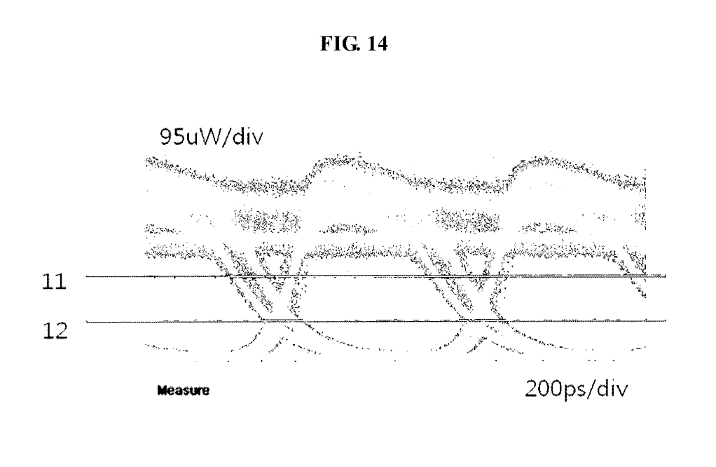

FIG. 14 is an eye diagram illustrating a received signal in a general optical receiver.

Referring to FIG. 14, noise elements generated due to conventional problems may have characteristics of being positioned in a level ‘1’ of an optical signal. In FIG. 14, when comparing a thickness of the level ‘1’ existing on an eye diagram and a thickness of a level ‘0’, a significant increase in the thickness of the level ‘1’ may be ascertained with the naked eyes due to re-modulation of a downstream optical signal (downstream optical wavelength signal).

Specifically, a significant reduction in an extinction ratio of the downstream optical signal may be shown due to a gain compression, that is, one of characteristics of the RSOA itself, however, a predetermined amount or more of the downstream optical signal may be remained.

When adopting an optical receiver including an existing photo diode, a pre-amplifier, and a post-amplifier, most decision threshold values may be fixed as a value (11 of FIG. 14) corresponding to an average of sizes of the level ‘1’ and the level ‘0’. In this instance, since the decision threshold values corresponding to the average are not be variable, when the thickness of the level ‘1’ is relatively great, a bit error ratio at the time of demodulation of a digital signal may be increased.

Also, the thickness of the level ‘1’ may increase due to a re-modulation process of the downstream optical signal, and a lengthening on an ascending and descending time of a digital modulation signal may increase due to slow frequency response characteristics, that is, one of characteristics of the RSOA itself. The lengthening on an ascending and descending time of a digital modulation signal may be converted to a timing jitter on a system, and in a case of using a conventional optical receiver, the timing jitter may be well understood as the biggest cause of a power penalty generated when transmitting an optical signal.

The WDM-PON having improved optical transmission characteristics according to an embodiment may adopt an optical receiver having a decision threshold value-variable function, so that an extinction ratio of a downstream optical signal may increase up to a predetermined level in the WDM-PON based on the RSOA recycling the downstream optical signal (downstream optical wavelength signal), thereby improving transmission quality of the downstream and upstream optical signal.

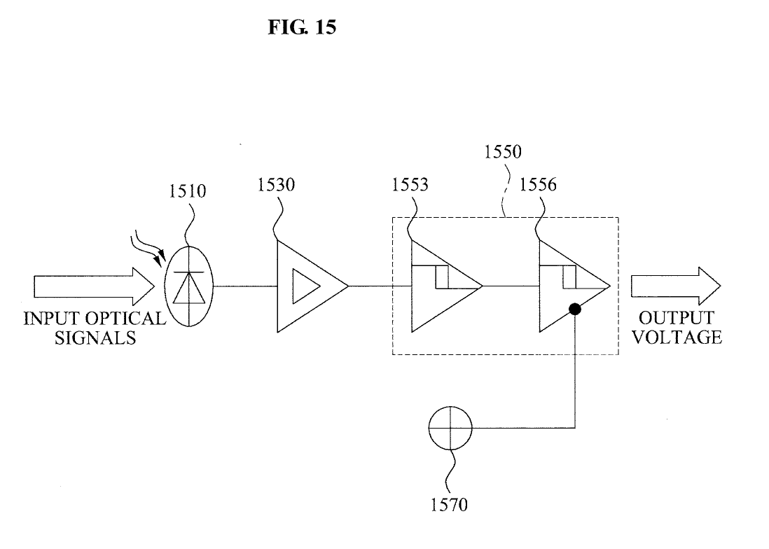

FIG. 15 is a diagram illustrating a configuration of an optical receiver according to an embodiment.

Referring to FIG. 15, the optical receiver according to an embodiment includes a photo diode 1510, a pre-amplification unit 1530, a post-amplification unit 1550, and an offset voltage generation unit 1570.

The photo diode 1510 may convert an entering downstream optical signal to a current electrical signal, and may include a positive-intrinsic-negative (PIN) type or an avalanche type.

The pre-amplification unit 1530 may convert, to a power signal, the electrical signal of a current signal type inputted from the photo diode 1510 to amplify the converted signal, and for example, may use a trans-impedance amplifier.

According to the present embodiment, in applications where continuous mode signals are received, the pre-amplification unit 1530 may be implemented by a pre-amplifier for a continuous mode, in a specific frequency band or less. Also, in applications where a burst mode signals are received, the pre-amplification unit 1530 may be implemented by a pre-amplifier for a burst mode, in a specific frequency band or less.

Specifically, the post-amplification unit 1550 may include a first post-amplification unit 1553 and a second post-amplification unit 1556.

The first post-amplification unit 1553 may be implemented by a post-amplifier having an automatic gain control function, so that an output voltage outputted from the pre-amplification unit 1530 may be maintained to have a predetermined level, in accordance with an input optical power within an input dynamic range of the optical receiver.

To configure a decision threshold value corresponding to noise distribution of signals inputted to the optical receiver, the second post-amplification unit 1556 may output signals that may have an appropriate crossing point on an output eye diagram and may be used for controlling the decision threshold value, when an appropriate DC offset voltage value corresponding to the noise distribution is inputted.

The DC offset voltage for controlling the decision threshold value provided to the second post-amplification unit 1556 may be received from the offset voltage generation unit 1570. According to the present embodiment, the first post-amplification unit 1553 and the second post-amplification unit 1556 may be integratedly configured or may be separately configured.

The offset voltage generation unit 1570 may include a voltage distribution unit (circuit) where a constant-voltage source having superior power security and an output of the constant-voltage source are changed in accordance with applications to be outputted. According to the present embodiment, a load resistance of the voltage distribution unit (circuit) may be implemented as a variable resistance.

Non-symmetric noise elements that are generated in a re-modulation process of the same wavelength-optical signal according to the wavelength reuse scheme and non-symmetric noise elements that are generated while transmitting the same wavelength-optical signal in two ways of a single optical fiber may be mainly distributed in a level ‘1’ of the optical signal. This will be understood with reference to FIG. 14. The optical signal illustrated in FIG. 14 may be inputted to the photo diode 1510 to be converted into electrical signals.

In this instance, the non-symmetric noise elements of the optical signal generated in the process of being converted into the electrical signals may be converted to electrical signals of a current signal type while maintaining most shapes and types of the non-symmetric noise elements without a change and distortion in the shape and type of the non-symmetric noise elements. A type of the photo diode 1510 used at this time may be determined by carefully considering an optical pass penalty and the like based on a power budget of a link itself to be applied and wavelength reuse.

Specifically, for example, when a transmission distance and the optical pass penalty are relatively great, an avalanche photo diode having a superior reception sensitivity performance may be desirably used. Desirably, since the avalanche photo diode requires a high bias driving voltage, an appropriate high bias voltage generation unit may be additionally implemented. Also, since most avalanche photo diodes have characteristics where a break-down voltage is changed in accordance with its operation temperature, a temperature compensation circuit for applying a bias voltage may be required to compensate this.

Also, for example, when the optical receiver for a short-distance transmission where the link power budget is relatively less is designed, a positive-intrinsic-negative (PIN) photo diode may be desirably used due to its economical advantage and a simple implementation circuit.

The pre-amplification unit 1530 may change the electrical signals photoelectrically converted in the photo diode 1510 to a signal format where a voltage is changed to enable the electrical signals to have reception level characteristics suitable for a digital communication system. According to the present embodiment, the pre-amplification unit 1530 may be implemented by the trans-impedance amplifier that is widely used for changing current signals to voltage signals.

Also, the pre-amplification unit 1530 may be desirably implemented by an optical amplifier having the automatic gain control function, however, when a relatively low input optical power level close to a reception sensitivity value is inputted, an output level for the input may be significantly reduced, or an output voltage may be reduced in proportion to a reduction in an input optical power.

Specifically, even though the pre-amplification unit 1530 has the automatic gain control function, there is a limitation where constant output characteristics are not provided within a total input dynamic range.

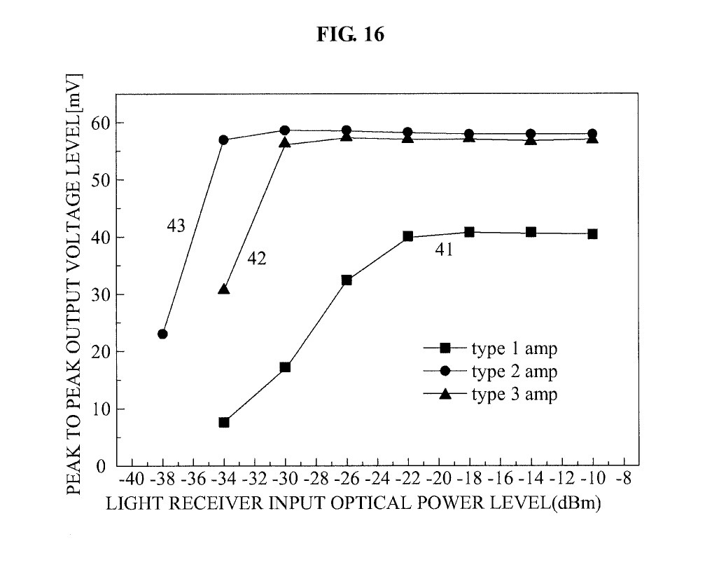

FIG. 16 is a graph illustrating a change performance of an output power level with respect to an input optical power in three types of pre-amplifiers in a WDM-PON having improved optical transmission characteristics according to an embodiment. In this instance, the three types of pre-amplifiers may use an avalanche photo diode.

Referring to FIG. 16, in most pre-amplifiers, when an input optical power is reduced to a value close to a reception sensitivity value, a peak-to-peak output voltage level may be significantly reduced. Thus, it may be difficult for constant voltage signals to be outputted only using the pre-amplifier having the automatic gain control function. This problem may be solved by the first post-amplification unit 1553 having the automatic gain control function according to an embodiment.

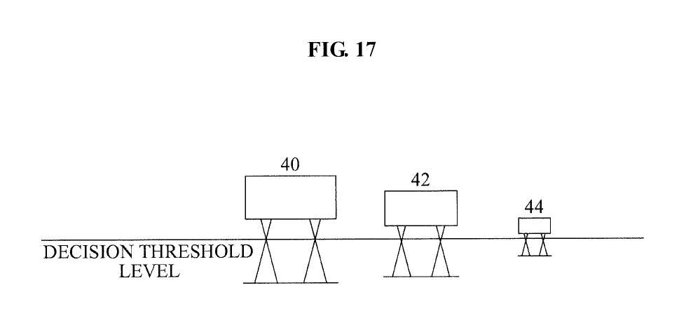

FIGS. 17 to 19 are diagrams illustrating a change of a decision threshold value depending on a change of an output power level in a WDM-PON having improved optical transmission characteristics according to an embodiment.

Specifically, in FIG. 17, a state where the decision threshold value is fixed as an arbitrary value when an output voltage level is changed with respect to an input optical power is illustrated. As an input optical power level inputted to the optical receiver is reduced in a stated order of 40, 42, and 44, a probability where an error occurs due to noise included in a level ‘1’, when discriminating signals may gradually increase.

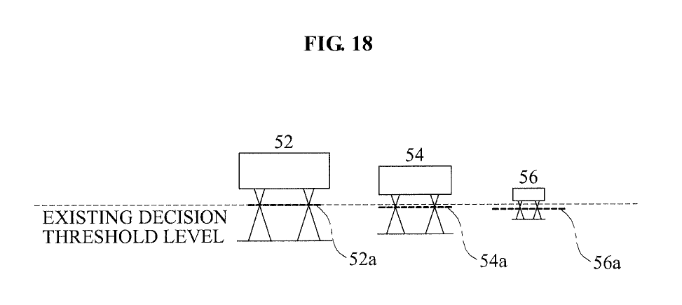

In this case, as illustrated in FIG. 18, a decision threshold level may need to be automatically changed depending on a change in the input optical power level. Specifically, when the input optical power level is gradually reduced in a stated order of 52, 54, and 56, a decision threshold value may need to be reduced in a stated order of 52a, 54a, and 56a in order to accurately receive the input signals reduced in this manner.

However, when the first post-amplification unit 1553 having a buffer type-automatic gain control function is used, the above described error may be reduced. In general, the post-amplifier may linear-amplify output signals of the pre-amplifier into an arbitrary level where a digital discrimination is performed. When an output level having the automatic gain control performed is provided to the second post-amplification unit 1556 together with the buffer type-automatic gain control function, an output signal level having the completely same intensity even in the reception sensitivity may be provided.

Thus, since an output is provided regardless of the input optical power level even though an intensity of noise elements remaining in the level ‘1’ is great as described above, there is no need to intentionally induce a change in the decision threshold value, as illustrated in FIG. 17. Specifically, even though a fixed decision threshold value is applied, a constant reception sensitivity performance may be maintained within the total input dynamic range of the optical receiver.

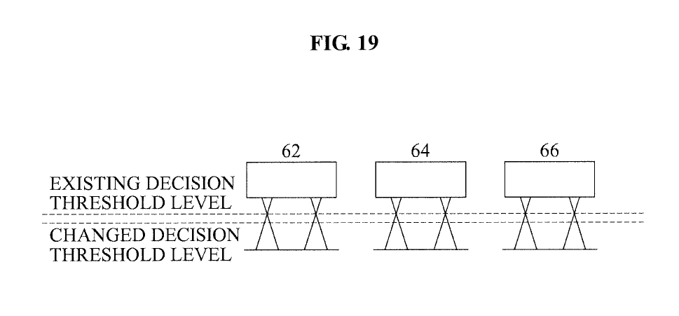

In FIG. 19, a state where the reception sensitivity performance is maintained is illustrated. In FIG. 19, since a signal level inputted to the second post-amplification unit 1556 is maintained to have a constant value even though an input optical power is reduced in a stated order of 62, 64, and 66, there is no need to change a decision threshold value in accordance with the input optical power. However, when a decision threshold value slightly lower than an existing decision threshold level is obtained, more excellent eye opening may be obtained, resulting in obtaining improved optical reception performance.

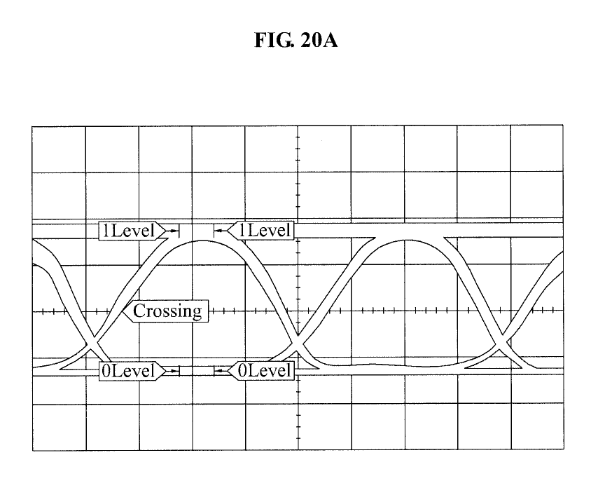

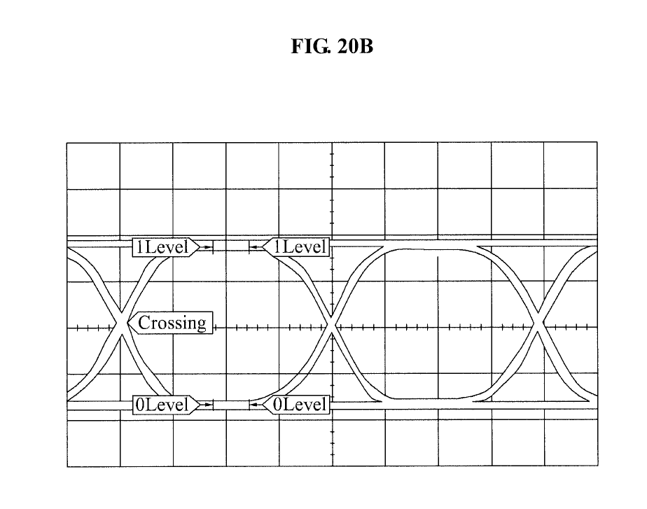

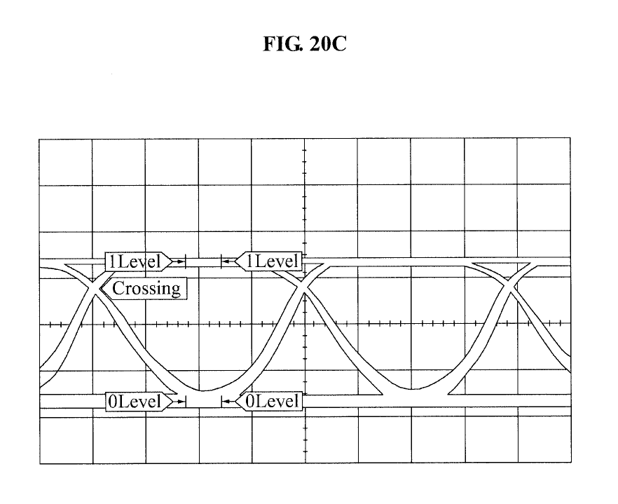

FIGS. 20A, 20B, and 20C are output eye diagrams with respect to an offset input voltage value of a second post-amplifier 1556 according to an embodiment.

According to the present embodiment, the second post-amplification unit 1556 may be implemented by a limiting amplifier where a decision threshold value is controlled.

When a specific voltage level is applied to a DC offset input terminal of the limiting amplifier, a crossing point on an output eye diagram may be changed. This change in the crossing point may be obtained by directly reflecting a change in the decision threshold value. By this change in the decision threshold value, reception characteristics of an optical signal may be improved.

In FIG. 20A, a result where a crossing point on the output eye diagram of the second post-amplification unit 1556 is made in a position of 20% of an intensity of a level ‘0’ by applying an arbitrary voltage level to the DC offset input terminal of the second post-amplification unit 1556 is illustrated. In this case, a decision threshold value in a click data recovery block may correspond to the crossing point of 20% on the eye diagram.

In FIG. 20B, a result where a crossing point on the output eye diagram of the second post-amplification unit 1556 is made in a position of 50% of an intensity of a level ‘0’ by applying another arbitrary voltage level to the DC offset input terminal of the second post-amplification unit 1556 is illustrated. This characteristic may correspond to a general characteristic of the optical receiver applied to a conventional optical communication system that does not have the variable function of the decision threshold value. In this case, the decision threshold value may correspond to the crossing point of 50% on the eye diagram.

In FIG. 20C, a result where a crossing point on the output eye diagram of the second post-amplification unit 1556 is made in a position of 80% made in a position of 20% of an intensity of a level ‘0’ through variation of the decision threshold value of the second post-amplification unit 1556. In this output eye diagram, the decision threshold value may be intentionally reduced to around the level ‘0’ when noise included in the level ‘1’ is larger than noise included in the level ‘0’, and a crossing point on the output eye diagram may seem to rise up to around the level ‘1’

In FIG. 20A, the decision threshold value may be intentionally increased when the noise included in the level ‘0’ is larger than the noise included in the level ‘1’. In this case, the crossing point on the output eye diagram may seem to lower down to the around the level ‘0’.

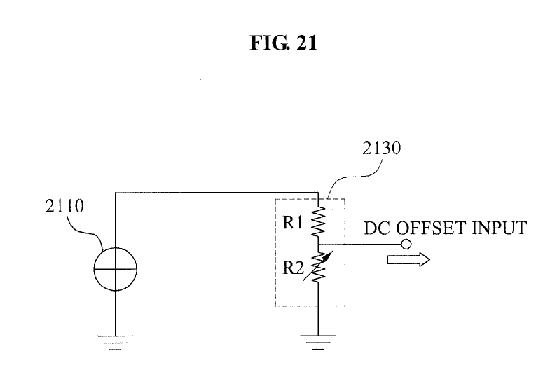

FIG. 21 is a diagram illustrating a configuration of an offset voltage generation unit 1570 according to an embodiment.

As illustrated in FIG. 21, the offset voltage generation unit includes a constant-voltage source 2110 to provide a constant voltage for generating a DC offset voltage and a voltage distribution unit 2130. The voltage distribution unit 2130 includes at least one resistance (R1 and/or R2), and may control and output a part of the constant voltage outputted from the constant voltage source 2110, in accordance with an intensity of the resistance (R1 and/or R2). In this instance, the resistance R2 may be desirably implemented as a variable resistance to variably control an output voltage.

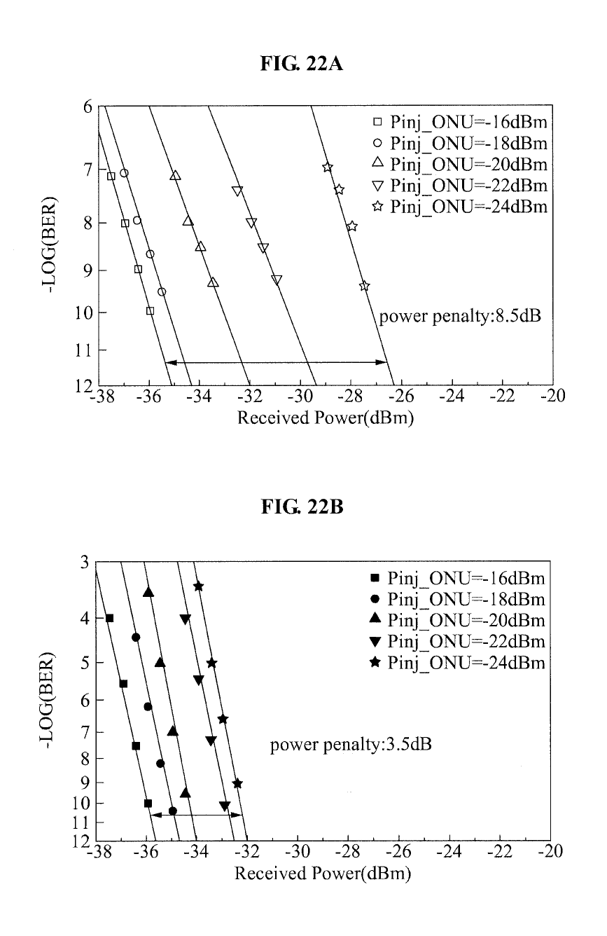

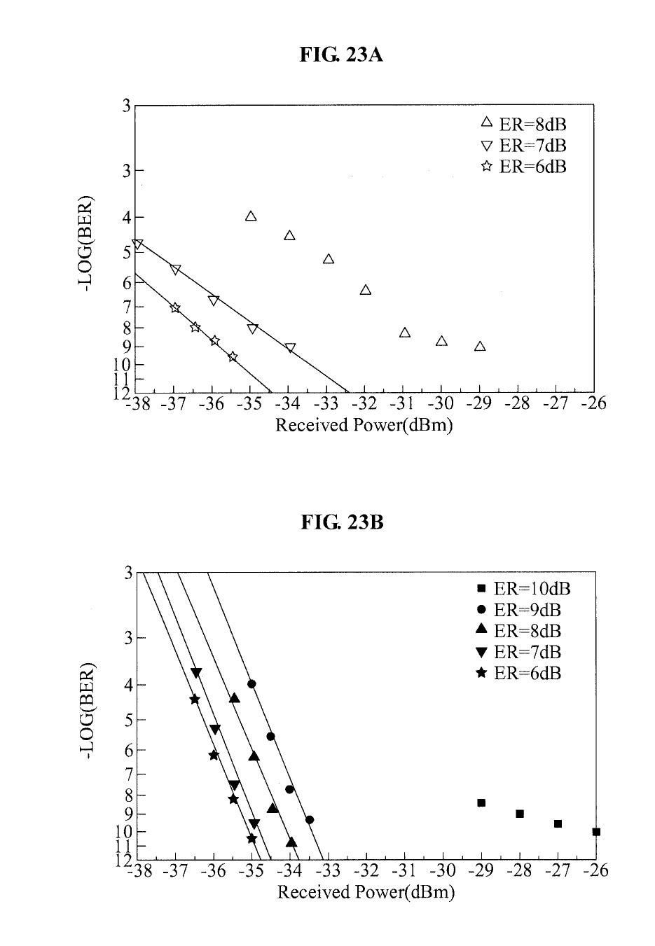

FIGS. 22A, 22B, 23A, and 23B are graphs illustrating a transmission test performance result in an optical receiver (Rx) according to an embodiment.

Specifically, FIGS. 22A and 22B are graphs illustrating reception signal characteristics when an extinction ratio of a downstream optical signal (downstream optical wavelength signal) is fixed.

FIG. 22A may show a transmission test result performed with respect to an upstream optical signal (upstream optical wavelength signal) measured using a conventional optical receiver while changing an optical power entering an RSOA-based optical transmitter positioned in an ONU/ONT after fixing an extinction ratio of the downstream optical signal (downstream optical wavelength signals) as 6 dB. Since a gain compression lacks along with a reduction in the input optical power, remaining extinction ratio elements of the downstream optical signal may increase, and thereby upstream transmission characteristics may be deteriorated.

In comparison with the input optical power of −16 dBm, when the input optical power is reduced to −24 dBm, an optical power penalty maximally reaching 8.5 dB may be shown.

In FIG. 22B where the optical receiver according to an embodiment is applied, the optical power penalty may be reduced to 3.5 dB, so that an improvement of about 5 dB may be shown.

FIGS. 23A and 23B are graphs illustrating reception signal characteristics obtained when an intensity of an optical power entering an optical transmitter. Specifically, FIGS. 23A and 23B are graphs illustrating a case where an extinction ratio of a downstream optical signal is changed up to 6 dB to 10 dB after fixing, to −15 dB, the optical power entering an RSOA-based optical transmitter positioned in an ONU/ONT.

FIG. 23A may show a result measured using a conventional optical receiver. In FIG. 23A, an error floor may be generated even though the extinction ratio of the downstream optical signal reaches 8 dB, so that a transmission is not performed.

Similar to this, since a gain compression lacks along with an increase in the extinction ratio of the downstream optical signal, remaining extinction ratio elements of the downstream optical signal may further increase, resulting in a deterioration in upstream transmission characteristics.

FIG. 23B may show a result measured using the optical receiver according to an embodiment. In FIG. 23B, a power penalty of about 2 dB may be obtained even though a downstream extinction ratio maximally reaches 9 dB, so that excellent transmission characteristics may be maintained.

Specifically, in FIGS. 22A, 22B, 23A, and 23B, when using the optical receiver according to an embodiment, a transmission of an upstream optical signal may be possible even though the extinction ratio of the downstream optical signal increases up to a predetermined level or more. Also, when the upstream optical signal obtained by re-modulating the downstream optical signal are transmitted, a transmission penalty having a predetermined level or more may be significantly reduced. Also, even though an intensity of the downstream optical signal inputted to the ONU/ONT is reduced to a predetermined level or less, a transmission may be possible.

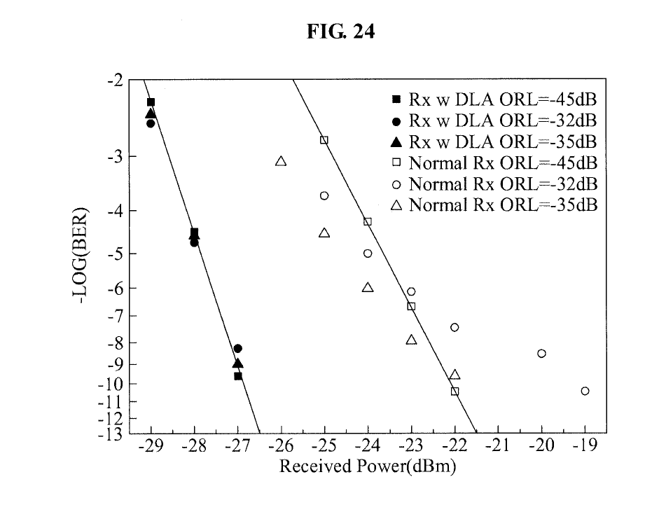

FIG. 24 is a diagram illustrating an improved result of a transmission penalty generated by retroreflection noise, by adopting an optical receiver according to an embodiment.

Specifically, FIG. 24 may show a transmission test performance result by an improvement in an optical power penalty generated due to reflection and Rayleigh backscattering at two-way transmission.

In FIG. 24, when using the optical receiver according to an embodiment in an upstream optical signal receiving unit of an RSOA-based Passive Optical Network (PON), a transmission test performance result that may improve the optical power penalty due to a bit intensity-noise generated by reflection and Rayleigh backscattering at two-way transmission of a single optical fiber is illustrated.

When a retroreflection occurs, reception sensitivity characteristics illustrated in FIG. 24 may be obtained regardless of a reflection amount in a case of using the optical receiver according to an embodiment, however, the error floor may be generated in a case of using a conventional optical receiver. Even when the retroreflection does not occur, an optical power penalty reaching about 5 dB may be obtained in a case of using the optical receiver according to an embodiment.

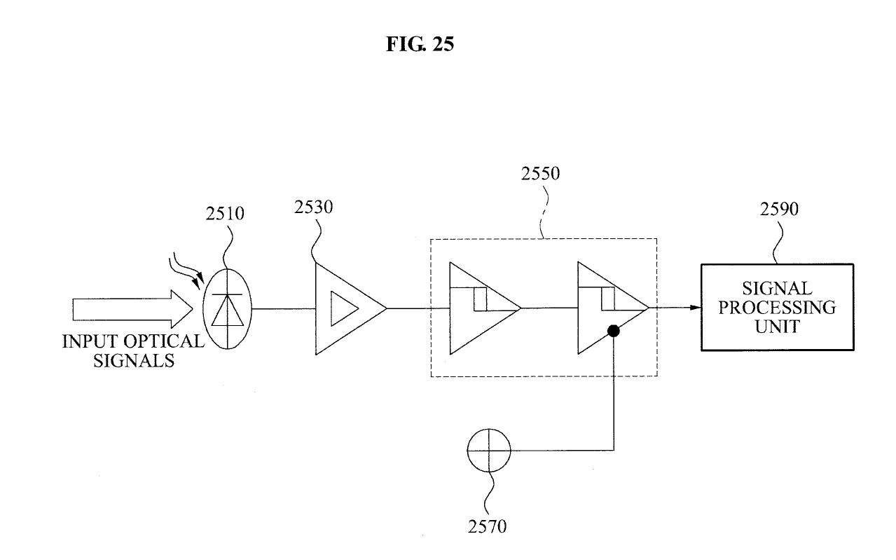

FIG. 25 is a block diagram illustrating an ONU/ONT in a WDM-PON having improved optical transmission characteristics according to an embodiment.

As illustrated in FIG. 25, the ONU/ONT according to an embodiment may include optical receivers (Rx) 2510, 2530, 2550, and 2570 and a signal processing unit 2590.

The signal processing unit 2590 may analyze, from the optical receiver, output signals where a decision threshold value is controlled, and perform a necessary processing. For example, the signal processing unit 2590 may generate a downstream link for transmitting restored signals to another ONU/ONT or an Optical Network Unit (ONU). According to an embodiment, a more accurate restoration of reception signals may be possible, and reliability in a signal processing in an optical communication network may be improved.

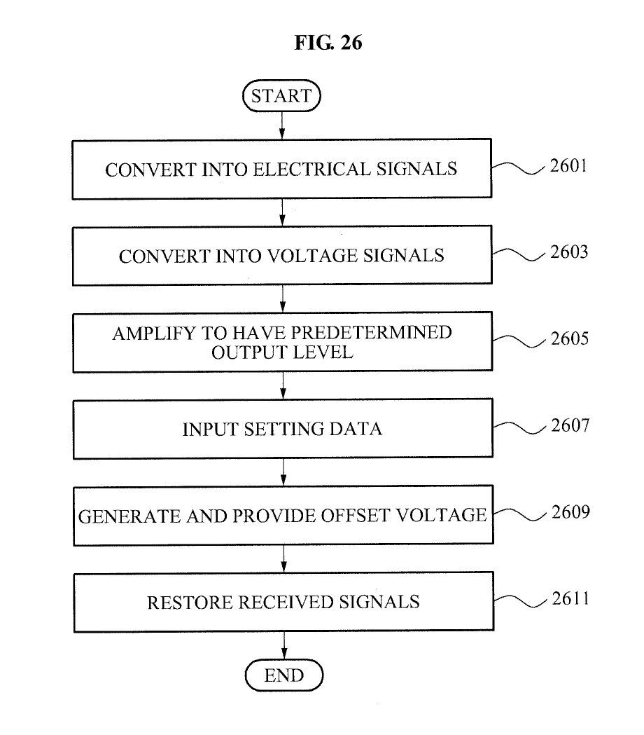

FIG. 26 is a flowchart illustrating a method of restoring received signals in an optical receiver (Rx) according to an embodiment.

Referring to FIG. 26, a photo diode of the optical receiver may convert, into electrical signals of a current signal type, an optical signal received from an RSOA in operation 2601, and amplify the electrical signals in a linear manner to convert the amplified electrical signals into voltage signals. The photo diode may amplify the converted voltage signals into signals having a predetermined constant output voltage level in operation 2605. The photo diode may receive setting data from a user to control a decision threshold value of the amplified output signals in operation 2607, and generate an offset voltage for controlling the decision threshold value based on the received setting data to provide the generated offset voltage to the optical receiver in operation 2609. The photo diode may restore reception signals where the decision threshold value is controlled, using the provided offset voltage in operation 2611. Thus, a more accurate restoration of the reception signals may be possible.

According to an embodiment, the offset voltage may be provided by varying a variable resistance included in a voltage distribution circuit for voltage-distributing a constant voltage provided from a constant voltage source.

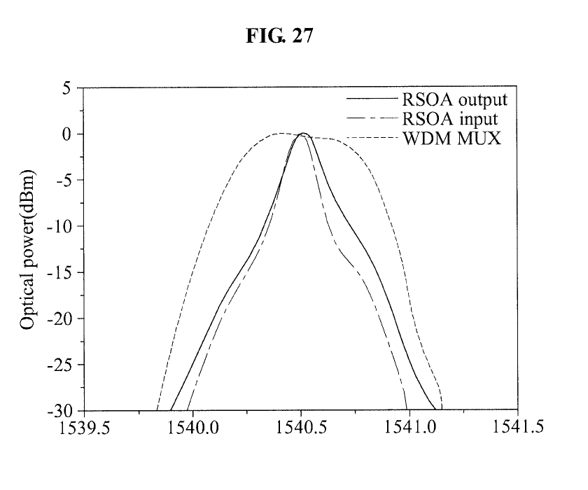

FIG. 27 is a diagram illustrating an optical signal inputted to a Reflective Semiconductor Optical amplifier (RSOA) from a WDM-PON having improved optical transmission characteristics according to another embodiment, an optical signal outputted from the RSOA, and a band pass spectrum of a first WDM multiplexer (MUX).

Referring to FIG. 27, since a band pass of the first WDM MUX is wider than a bandwidth of the output optical signal of the RSOA, a change in signal optical characteristics may not be generated even though the optical signal passes through the first WDM MUX.

As described above, according to an embodiment, the WDM-PON according to an embodiment may use the seed light having been spectrum-sliced, a loss occurring due to a spectrum division generated when the seed light passes through the WDM MUX of the OLT of the WDM-PON positioned on a communication link may be significantly reduced. Also, since an optical signal exists within a pass band of the WDM MUX even though an output spectrum of the optical signal is distorted by a non-linear optical amplification phenomenon generated in the RSOA, a loss of data frequency elements may not occur, thereby effectively transmitting signals.

Also, according to an embodiment, by adopting the optical receiver having the decision threshold value-variable function, the extinction ratio of the downstream optical signal may increase up to a predetermined level, thereby improving a transmission quality of the downstream optical signal. Also, an input optical power operation range of the RSOA may be reduced to a gain saturation-input optical power level or less, thereby improving a link power budget.

Also, according to an embodiment, upstream/downstream transmission penalty generated by retroreflection related-optical intensity noise generated at two-way transmission of a single optical fiber may be improved, and a transmission quality of the upstream optical signal may be improved due to the increased extinction ratio of the downstream optical signal. In addition, when using a broadband optical source based on an optical amplifier where an erbium having been spectrum-sliced as the seed light is added, the transmission quality of the upstream/downstream optical signal may be improved due to an increase in generated relative optical strength noise.

The methods according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments have been shown and described, it would be appreciated by those skilled in the art that changes may be made in these embodiments without departing from the principles and spirit of the disclosure, the scope of which is defined by the claims and their equivalents.

What is claimed is:

1. An Optical Line Terminal (OLT), comprising:
a first Wavelength division multiplexer/demultiplexer to perform a wavelength demultiplexing on seed light received from a seed light source; and
a second Wavelength division demultiplexer to receive, from at least one ONU/ONT, an upstream optical signal generated using the downstream optical signal having the wavelength demultiplexing performed, and to perform a wavelength demultiplexing on the received upstream optical signal.

2. The OLT of claim 1, further comprising:
at least one Reflective Semiconductor Optical amplifier (RSOA) or at least one Fabry Perot Laser Diode (FP-LD), the at least one RSOA and the at least one FP-LD amplifying and modulating the seed light having the wavelength demultiplexing performed to generate a downstream optical signal,
wherein the first Wavelength division multiplexer/demultiplexer transmits, to the at least one ONU/ONT, the downstream optical signal received from the at least one RSOA or the at least one FP-LD.

3. The OLT of claim 1, wherein the pass band of first Wavelength division multiplexer/demultiplexer is wider and flatter than an optical bandwidth of the seed light.

4. The OLT of claim 1, wherein the second Wavelength division demultiplexer is connected to at least one optical receiver (Rx), and the at least one optical receiver (Rx) receives, from the second Wavelength division demultiplexer, the upstream optical signal having the wavelength demultiplexing performed.

5. The OLT of claim 4, wherein the at least one optical receiver (Rx) determines a power level of the upstream optical signal having the wavelength demultiplexing performed to adjust a predetermined voltage threshold value.

6. A seed light source which includes a first optical amplifier to amplify ASE light and to output the amplified ASE light as a seed light, and enables a backward ASE light to re-inject the first optical amplifier to thereby amplify the re-injecting backward ASE light, the backward ASE light being outputted in an opposite direction of an output direction of the seed light.

7. The seed light source of claim 6, further comprising:
an optical wavelength filter to receive the backward ASE light and to enable the received backward ASE light to be transmitted through the optical wavelength filter in a periodic frequency interval to thereby spectrum-slice the transmitted ASE light.

8. The seed light source of claim 7, further comprising:
a reflection mirror to reflect the spectrum-sliced ASE light and to enable the reflected ASE light to re-inject the optical wavelength filter.

9. The seed light source of claim 7, further comprising:
an optical circulator to be positioned between the first optical amplifier and the optical wavelength filter to circulate the ASE light outputted from the first optical amplifier, using the optical wavelength filter, and to enable the spectrum-sliced ASE light to re-inject the first optical amplifier through the optical wavelength filter.

10. The seed light source of claim 7, wherein the first optical amplifier comprises:
an optical fiber corresponding to a gain medium;
a pump light source to inject external light in the optical fiber to generate a pump light used for generating an optical carrier; and
an optical wavelength coupler to enable the pump light to enter the optical fiber.

11. The seed light source of claim 7, wherein the optical wavelength filter adjusts an interval and width of the spectrum in accordance with output characteristics of the seed light.

12. The seed light source of claim 7, further comprising:
a second optical amplifier to re-amplify the seed light outputted from the first optical amplifier

13. The seed light source of claim 7, further comprising:
a Gain Flattening Filter (GFF) to flatten an intensity of the seed light for each channel by adjusting a loss for each channel of the spectrum-sliced backward ASE light.

14. The seed light source of claim 7, further comprising:
a band pass filter to adjust a number of channels of the seed light by enabling only a frequency of a predetermined band of the spectrum-sliced backward ASE light to be transmitted through the optical wavelength filter.

15. An ONT/ONU, comprising: an optical power splitter to distribute downstream optical signal having been wavelength-multiplexed in an Wavelength division multiplexer, in a predetermined ratio;
an optical receiver (Rx) to receive the distributed downstream optical signal; and
a Reflective Semiconductor Optical amplifier (RSOA) to receive the distributed downstream optical signal, and to amplify and modulate the received downstream optical signal to generate the upstream optical signal.

16. The ONU/ONT of claim 15, wherein the optical receiver adjusts a predetermined voltage threshold value by determining a level of the received downstream optical signal.

17. The ONU/ONT of claim 15, wherein the optical receiver comprises:
a photo diode to convert the downstream optical signal to electrical signal of a current signal type;
a pre-amplification unit to covert the electrical signal to power signal and to amplify the converted signal;
a first post-amplification unit to enable an output power of the pre-amplification unit to maintain a predetermined level;
a second post-amplification unit to control a predetermined decision threshold value by receiving a direct current (DC) offset power value corresponding to noise distribution of signals inputted to the optical receiver; and
an offset voltage generation unit to provide, to the second post-amplification unit, the DC offset power value for controlling the predetermined decision threshold value.

18. The ONU/ONTONU/ONT of claim 17, wherein the offset voltage generation unit comprises:
a constant-voltage source to provide a constant-voltage; and
a power distribution unit to include at least one resistance, and to control a part of the constant-voltage in accordance with a resistance value of the at least one resistance to output the controlled constant-voltage.

19. The ONU/ONTONU/ONT of claim 17, further comprising:
a signal processing unit to analyze and process output signal where the predetermined decision value is controlled.
